(19) United States
(12) Patent Application Publication
(10) Pub. No.: US 2025/0249755 A1
(43) Pub. Date: Aug. 7, 2025

(54) VEHICLE CONTROL DEVICE

(71) Applicant: MITSUBISHI JIDOSHA KOGYO KABUSHIKI KAISHA, Tokyo (JP)

(72) Inventor: Ryosuke KOGA, Tokyo (JP)

(73) Assignee: MITSUBISHI JIDOSHA KOGYO KABUSHIKI KAISHA, Tokyo (JP)

(21) Appl. No.: 18/843,617

(22) PCT Filed: Mar. 1, 2023
(86) PCT No.: PCT/JP2023/007460

§ 371 Date: Apr. 16, 2025

(30) Foreign Application Priority Data
Mar. 23, 2022 (JP) 2022-047031

(51) Int. Cl. B60L 15/20; B60R 16/023

(52) U.S. Cl. CPC B60L 15/20; B60R 16/0231; B60L 2240/12; B60L 2240/16; B60L 2240/461

(57) ABSTRACT

An electronic control unit (ECU) 10 includes: a delay correction amount calculation unit 120 that calculates, as a delay correction amount α, an estimated increase or decrease in vehicle body speed during a delay time occurring when a wheel speed ωw is acquired through a wheel speed sensor and controller area network (CAN) communication, the calculation being based on one of a front-rear acceleration X of an electric vehicle 1 and an estimated vehicle body speed V; an error correction unit 130 that calculates a corrected past estimated vehicle body speed Vp′, obtained by correcting a past estimated vehicle body speed Vp, based on an error ΔV between the past estimated vehicle body speed Vp and a CAN vehicle body speed Vs, the past estimated vehicle body speed being the estimated vehicle body speed V calculated earlier by the delay time, the CAN vehicle body speed being based on the wheel speed ωw acquired through CAN communication; and a vehicle body speed calculation unit 140 that calculates the current estimated vehicle body speed V by adding the delay correction amount α and the corrected past estimated vehicle body speed Vp′.

### TECHNICAL FIELD

The present invention relates to a vehicle control device, and in particular to a control device for estimating a vehicle body speed.

### BACKGROUND ART

Conventional techniques for estimating a vehicle body speed of a vehicle are known. For example, Patent Document 1 describes a vehicle speed estimation device that calculates an estimated value of a vehicle body speed by applying a first-order delay filter process to a wheel speed, and further calculates a corrected estimated value of a vehicle body speed by adding, to the calculated estimated value of the vehicle body speed, a front-rear acceleration multiplied by the transfer function of the filter and a time constant.

### PRIOR ART DOCUMENT

### Patent Document

Patent Document 1: Japanese Patent Laid-Open No. 10-217934

### SUMMARY OF THE INVENTION

### Problems to be Solved by the Invention

For vehicles equipped with electric motors for travel, traction control that takes advantage of the high torque response of the electric motors is expected to improve starting performance. The value of the wheel speed of a vehicle detected by a sensor may be transmitted to a motor controller from another controller through controller area network (CAN) communication. Therefore, the vehicle body speed is estimated using the wheel speed at a time earlier by the delay time of the CAN communication delay and the sensor detection delay. However, although the vehicle body speed estimation device described in Patent Document 1 considers the delay time due to the filter process, the device cannot obtain the vehicle body speed considering the delay time. As a result, it may not be possible to execute control that sufficiently takes advantage of the torque response of the electric motor.

The present invention has been made in view of such problems, and it is an object of the present invention to provide a vehicle control device that can estimate a vehicle body speed more appropriately by considering a delay time until the wheel speed is detected by a sensor and acquired through CAN communication.

### Means for Solving the Problems

In order to achieve the above object, a vehicle control device of the present invention is a vehicle control device for calculating an estimated vehicle body speed of a vehicle equipped with an electric motor for travel, the vehicle control device including: a delay correction amount calculation unit that calculates, as a delay correction amount, an estimated increase or decrease in vehicle body speed during a delay time occurring when a wheel speed is acquired through a sensor and CAN communication, the calculation being based on one of a front-rear acceleration of the vehicle or the estimated vehicle body speed; an error correction unit that calculates a corrected past estimated vehicle body speed, obtained by correcting a past estimated vehicle body speed, based on an error between the past estimated vehicle body speed and the vehicle body speed, the past estimated vehicle body speed being the estimated vehicle body speed calculated earlier by the delay time, the vehicle body speed being based on the wheel speed acquired through CAN communication; and a vehicle body speed calculation unit that calculates the estimated vehicle body speed at present by adding the delay correction amount and the corrected past estimated vehicle body speed.

With this configuration, the past estimated vehicle body speed, calculated earlier by the delay time of the CAN communication delay and the sensor detection delay, can be corrected based on the wheel speed acquired through CAN communication to accurately calculate the corrected past estimated vehicle body speed that serves as a base. The current estimated vehicle body speed is calculated by adding the delay correction amount, which is the estimated increase or decrease in vehicle body speed during the delay time, to the corrected past estimated vehicle body speed, thus enabling the compensation of the vehicle body speed for the delay time. Therefore, the vehicle body speed can be estimated more appropriately by considering the delay time until the wheel speed is detected by the sensor and acquired through CAN communication.

Further, the delay correction amount calculation unit preferably calculates an integrated value of the front-rear acceleration of the vehicle during the delay time as the delay correction amount. With this configuration, the delay correction amount calculation unit can appropriately calculate the delay correction amount based on the front-rear acceleration.

Further, the front-rear acceleration is preferably a value detected by an acceleration sensor installed in the vehicle. With this configuration, the front-rear acceleration can be easily acquired.

Further, the front-rear acceleration is preferably a value calculated based on the wheel speed. With this configuration, the front-rear acceleration can be acquired only by the wheel speed sensor for detecting the wheel speed without using the acceleration sensor.

Further, the front-rear acceleration is preferably a value calculated based on the estimated vehicle body speed. With this configuration, the front-rear acceleration can be acquired without using the acceleration sensor or the wheel speed sensor.

Further, the front-rear acceleration is preferably a value calculated based on a driving force and a braking force of the vehicle. With this configuration, the front-rear acceleration can be acquired without using the acceleration sensor or the wheel speed sensor.

Further, the integrated value is preferably an integrated value of a corrected acceleration obtained by correcting a disturbance component including a road surface gradient. With this configuration, the integrated value can be calculated more accurately.

Further, when a previous estimated vehicle body speed, which is the estimated vehicle body speed calculated in a previous process, is equal to or greater than a predetermined speed, the delay correction amount calculation unit preferably sets a difference between the previous estimated vehicle body speed and the past estimated vehicle body speed as the delay correction amount. When the previous estimated vehicle body speed is less than the predetermined speed, the delay correction amount calculation unit preferably sets the integrated value of the front-rear acceleration of the vehicle during the delay time as the delay correction amount.

With this configuration, the delay correction amount calculation unit can accurately calculate the delay correction amount by simple calculation without using the front-rear acceleration in a speed region equal to or greater than a predetermined speed. In addition, the delay correction amount calculation unit can appropriately calculate the delay correction amount based on the front-rear acceleration in a speed region less than the predetermined speed.

### Advantageous Effects of the Invention

In the vehicle control device of the present invention, the current estimated vehicle body speed is calculated by adding the delay correction amount, which is an estimated increase or decrease in vehicle body speed during the delay time, to the corrected past estimated vehicle body speed. The corrected past estimated vehicle body speed is obtained by correcting the past estimated vehicle body speed based on the wheel speed acquired through CAN communication, the past estimated vehicle body speed having been calculated earlier by the delay time of the CAN communication delay and the sensor detection delay. Therefore, the vehicle body speed can be estimated more appropriately by considering the delay time until the wheel speed is detected by the sensor and acquired through CAN communication.

### BRIEF DESCRIPTION OF THE DRAWINGS

FIG. 1 is a schematic configuration diagram illustrating an example of an electric vehicle equipped with an ECU as a control device according to an embodiment.

FIG. 2 is a schematic configuration diagram illustrating an example of the ECU.

FIG. 3 is an explanatory diagram schematically illustrating the time variations of an actual vehicle body speed when the electric vehicle is traveling at a constant speed, a wheel speed acquired by the ECU through CAN communication, and a conventional estimated vehicle body speed calculated based on the wheel speed.

FIG. 4 is an explanatory diagram schematically illustrating the time variations of the actual vehicle body speed when the electric vehicle is traveling at a constant speed in an extremely low-speed region, the wheel speed acquired by the ECU through CAN communication, and the conventional estimated vehicle body speed calculated based on the wheel speed.

FIG. 5 is a control block diagram illustrating an example of an estimated vehicle body speed calculation unit.

FIG. 6 is a control block diagram illustrating an example of a traction control unit.

FIG. 7 is a flowchart illustrating an example of an estimated vehicle body speed calculation process.

FIG. 8 is an explanatory diagram illustrating an example of experimental results in which an estimated vehicle body speed was calculated using the estimated vehicle body speed calculation process according to the embodiment.

FIG. 9 is an explanatory diagram schematically illustrating the time variations of a reference rotational speed of a drive shaft and the wheel speed.

FIG. 10 is a control block diagram illustrating an example of the configuration of the traction control unit.

FIG. 11 is an explanatory diagram illustrating an example of experimental results in which an estimated drive shaft rotational speed was calculated by the ECU according to the embodiment.

### MODE FOR CARRYING OUT THE INVENTION

Hereinafter, an embodiment of the present invention will be described based on the drawings.

### (Electric Vehicle)

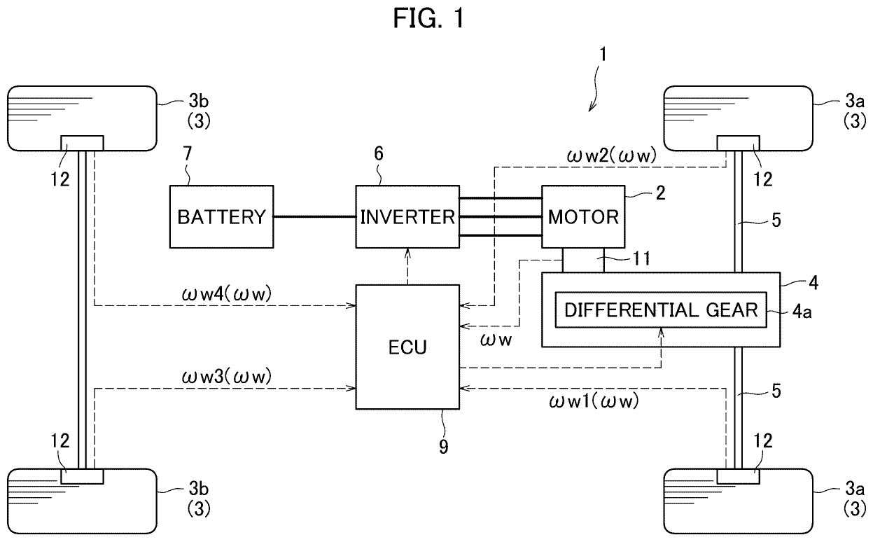

FIG. 1 is a schematic configuration diagram illustrating an example of an electric vehicle equipped with an ECU as a control device according to the embodiment. An electric vehicle 1 is a front-wheel-drive vehicle in which front wheels 3a, which are drive wheels among wheel 3, are driven by an electric motor 2 (electric motor for travel) installed as a power source for travel. The output shaft of the motor 2 is coupled to the left and right front wheels 3a via a drive shaft 5 through a reduction mechanism 4 that incorporates a differential gear 4a. Note that the reduction mechanism 4 may include a shift mechanism. The motor 2 is connected to an inverter 6 through a power line, and the inverter 6 is connected to a battery 7. The inverter 6 performs a direct current (DC) to alternating current (AC) conversion function. The inverter 6 converts DC power supplied from the battery 7 into three-phase AC power to supply the converted power to the motor 2 during the power drive control of the motor 2, and converts regenerative power from the motor 2 into DC power to charge the battery 7 during the regenerative control of the motor 2.

### (ECU)

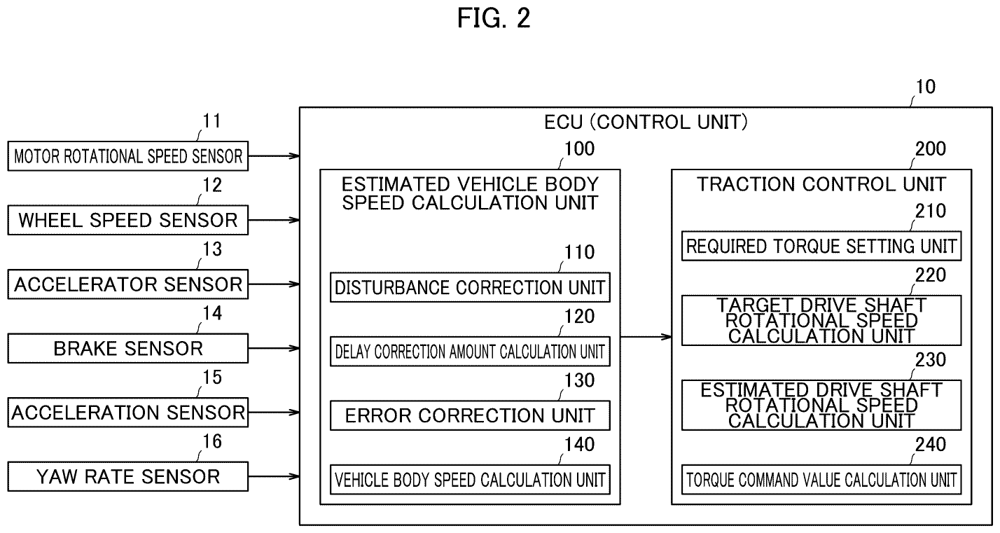

The electric vehicle 1 is equipped with an ECU 10 (control device) as a motor controller that drives and controls the motor 2. The ECU 10 includes an input/output device, storage devices (read-only memory (ROM), random-access memory (RAM), nonvolatile RAM, etc.), a central processing unit (CPU), and the like. FIG. 2 is a schematic configuration diagram illustrating an example of the ECU 10. Various sensors are connected to the input side of the ECU 10 through CAN, including a motor rotational speed sensor 11 that detects a motor rotational speed ωm of the motor 2, a wheel speed sensor 12 that detects wheel speeds ωw (ωw1 to ωw4) of the left and right front wheels 3a and left and right rear wheels 3b, an accelerator sensor 13 that detects an accelerator operation amount, a brake sensor 14 that detects a brake operation amount, an acceleration sensor 15 that detects a front-rear acceleration X of the electric vehicle 1, and a yaw rate sensor 16 that detects a yaw rate y of the electric vehicle 1. The motor rotational speed sensor 11 and the wheel speed sensor 12 may be well-known rotation sensors that can detect rotational speed, such as rotary encoders. In the present embodiment, the acceleration sensor 15 is a G sensor. In addition, the inverter 6 is connected to the output side of the ECU 10. The ECU 10 is then equipped with an estimated vehicle body speed calculation unit 100 and a traction control unit 200.

### (Estimated Vehicle Body Speed Calculation Unit)

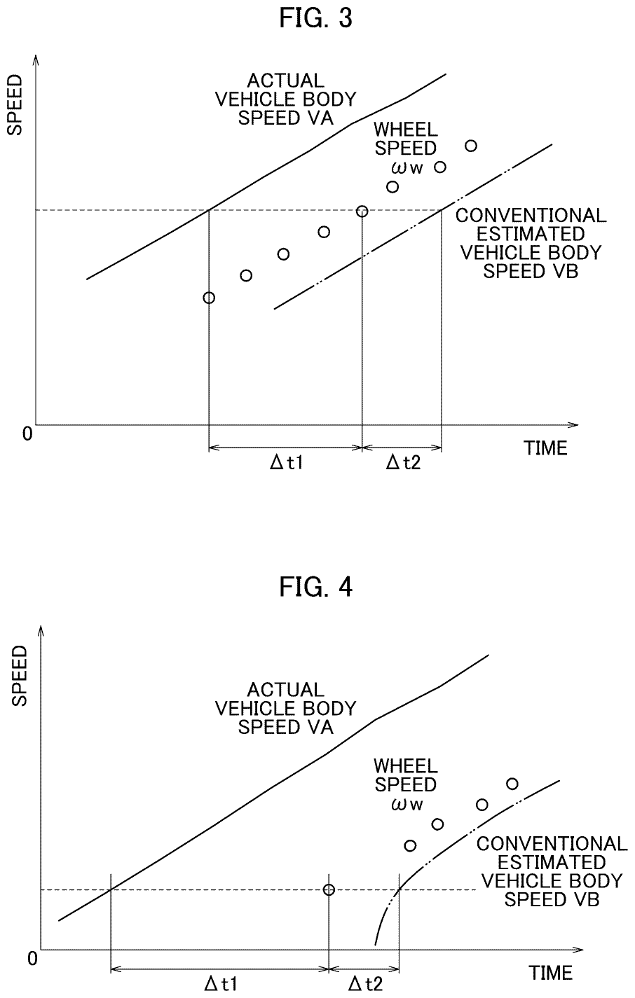

First, the configuration and operation of the estimated vehicle body speed calculation unit 100 will be described. Here, FIG. 3 is an explanatory diagram schematically illustrating the time variations of an actual vehicle body speed VA when the electric vehicle 1 is traveling at a constant speed, a wheel speed ωw acquired by the ECU 10 through CAN communication, and a conventional estimated vehicle body speed VB calculated based on the wheel speed ωw. FIG. 4 is an explanatory diagram schematically illustrating the time variations of the actual vehicle body speed VA when the electric vehicle 1 is traveling at a constant speed in an extremely low-speed region, the wheel speed ωw acquired by the ECU 10 through CAN communication, and the conventional estimated vehicle body speed VB calculated based on the wheel speed ωw. Note that the conventional estimated vehicle body speed VB, indicated by the dash-double-dots line, is an estimated vehicle body speed calculated using the conventional method, such as by applying a filter process like a low-pass filter to the wheel speed ωw.

As indicated by the white circle in FIG. 3, the wheel speed ωw acquired through CAN communication is delayed with respect to the actual vehicle body speed VA by a delay time Δt1 due to the delay of CAN communication. The conventional estimated vehicle body speed VB is further delayed from the actual vehicle body speed VA by a delay time Δt2 due to the filter process.

As illustrated in FIG. 4, in the extremely low-speed region, the delay time Δt1 becomes even longer due to the occurrence of the detection delay caused by the insufficient number of teeth of the wheel speed sensor 12, such as the rotary encoder, and the wheel speed ωw and the conventional estimated vehicle body speed VB are further delayed with respect to the actual vehicle body speed VA. When the conventional estimated vehicle body speed VB is calculated with a delay from the actual vehicle body speed VA as described above, it may not be possible to fully expect the effect of improving starting performance through traction control that takes advantage of the high torque response of the motor 2. Therefore, in the ECU 10 of the electric vehicle 1 of the present embodiment, the estimated vehicle body speed calculation unit 100 calculates the estimated vehicle body speed of the electric vehicle 1 more appropriately.

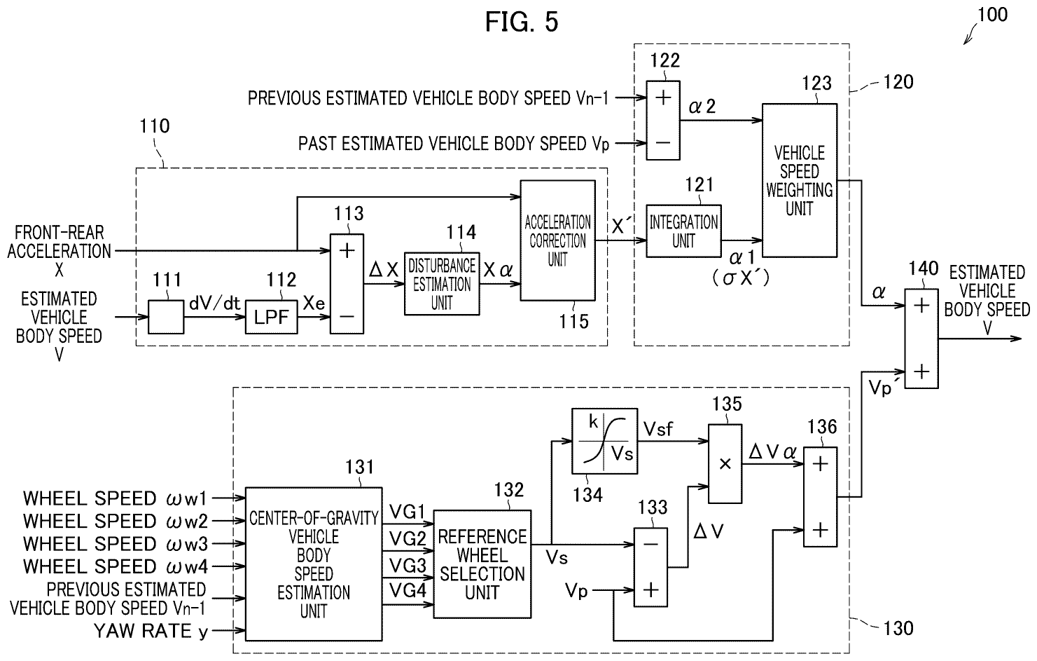

FIG. 5 is a control block diagram illustrating an example of the estimated vehicle body speed calculation unit 100. The estimated vehicle body speed calculation unit 100 executes an estimated vehicle body speed calculation process to calculate an estimated vehicle body speed V of the electric vehicle 1. As illustrated in FIGS. 2 and 5, the estimated vehicle body speed calculation unit 100 includes a disturbance correction unit 110, a delay correction amount calculation unit 120, an error correction unit 130, and a vehicle body speed calculation unit 140.

### (Acceleration Disturbance Correction Unit)

The disturbance correction unit 110 acquires the front-rear acceleration X of the electric vehicle 1, detected by the acceleration sensor 15, through CAN communication. Further, the disturbance correction unit 110 acquires the estimated vehicle body speed V, which is finally calculated by the estimated vehicle body speed calculation unit 100, and calculates a derivative value dV/dt within the delay time Δt1 in a derivative block 111. As described above, when the ECU 10 acquires the wheel speed ωw detected by the wheel speed sensor 12, the delay time Δt1 is a delay time caused by the communication delay of CAN communication or the insufficient number of teeth of the wheel speed sensor 12, and is a value of about several ms to several hundred ms. For the delay time Δt1, a value corresponding to the vehicle conditions may be determined in advance through experimentation, analysis, and the like using a map and other means. The derivative value dV/dt is the estimated value of the front-rear acceleration of the electric vehicle 1 during the delay time Δt1. Moreover, the disturbance correction unit 110 calculates, in a low-pass filter block 112, an estimated acceleration Xe obtained by applying a predetermined low-pass filter process to the derivative value dV/dt. Then, the disturbance correction unit 110 calculates a difference ΔX between the front-rear acceleration X and the estimated acceleration Xe in a difference block 113, and calculates a disturbance component Xα based on the difference ΔX in a disturbance estimation unit 114. The disturbance component Xα is, for example, a disturbance component caused by a road surface gradient detected by the acceleration sensor 15 that is the G sensor. In the present embodiment, the disturbance correction unit 110 calculates the difference ΔX as the disturbance component Xα of the acceleration. Note that disturbance components other than the road surface gradient may be considered for the disturbance component Xα, and the disturbance correction unit 110 may calculate the disturbance component using a well-known method based on the difference ΔX. Then, the disturbance correction unit 110 calculates a corrected acceleration X′ by subtracting the disturbance component Xα from the front-rear acceleration X in an acceleration correction unit 115.

### (Delay Correction Amount Calculation Unit)

The delay correction amount calculation unit 120 acquires the corrected acceleration X′ from the disturbance correction unit 110 and calculates, in an integration unit 121, an integrated value σX′ obtained by integrating the corrected acceleration X′ during the delay time Δt1. The integrated value σX′ is an estimated increase or decrease in the vehicle body speed of the electric vehicle 1 during the delay time Δt1, and the delay correction amount calculation unit 120 sets the integrated value σX′ as a delay correction amount α of the vehicle body speed. In the following description, the integrated value σX′ is referred to as a first delay correction amount α1, as appropriate.

The delay correction amount calculation unit 120 also calculates the delay correction amount α based on the variation amount of the estimated vehicle body speed V. Specifically, among the estimated vehicle body speeds V that are finally calculated by the estimated vehicle body speed calculation unit 100, the delay correction amount calculation unit 120 acquires a previous estimated vehicle body speed Vn-1 calculated using the previous process and a past estimated vehicle body speed Vp calculated earlier by the delay time Δt1. The previous estimated vehicle body speed Vn-1 is used instead of the current estimated vehicle body speed V. The delay correction amount calculation unit 120 calculates the difference between the previous estimated vehicle body speed Vn-1 and the past estimated vehicle body speed Vp in a difference block 122, and sets the calculated difference as the delay correction amount α. In the following description, the difference between the previous estimated vehicle body speed Vn-1 and the past estimated vehicle body speed Vp is referred to as a second delay correction amount α2, as appropriate.

When calculating and setting the delay correction amount α (first delay correction amount α1 and second delay correction amount (α2) as described above, the delay correction amount calculation unit 120 determines which of the first delay correction amount α1 and the second delay correction amount α2 is selected in a vehicle speed weighting unit 123. Specifically, when the absolute value of the current vehicle body speed is less than a first predetermined speed V1 (predetermined speed), the first delay correction amount α1 is selected and output. On the other hand, when the absolute value of the current vehicle body speed is equal to or greater than the first predetermined speed V1, the second delay correction amount α2 is selected and output. Note that the previous estimated vehicle body speed Vn-1 may be used for the current vehicle body speed here. That is, the first delay correction amount α1, which is the integrated value σX′ of the corrected acceleration X′, is preferably used in a region where the current vehicle body speed has not reached a sufficient speed because this region includes an area where the calculation accuracy of the estimated vehicle body speed V, to be described later, is relatively low (cf. FIG. 8) compared to a region where the current vehicle body speed has reached the sufficient speed. On the other hand, in a region where the current vehicle body speed is sufficiently high, the second delay correction amount α2, which is the difference between the previous estimated vehicle body speed Vn-1 and the past estimated vehicle body speed Vp, can be used because the calculation accuracy of the estimated vehicle body speed V, to be described later, is relatively high (cf. FIG. 8). For example, the first predetermined speed V1 is preferably 10 m/s or more and less than 70 m/s, more preferably 20 m/s or more and less than 70 m/s, and even more preferably 27 m/s or more and less than 70 m/s.

### (Error Correction Unit)

The error correction unit 130 acquires the wheel speeds ωw1 to ωw4 from the wheel speed sensor 12 through CAN communication, and acquires the yaw rate y of the electric vehicle 1 detected by the yaw rate sensor 16. In addition, the error correction unit 130 acquires the previous estimated vehicle body speed Vn-1 as a substitute for the current vehicle body speed. The error correction unit 130 calculates, in a center-of-gravity vehicle body speed estimation unit 131, center-of-gravity vehicle body speeds VG1, VG2, VG3, VG4, which are speeds at the center-of-gravity position of the electric vehicle 1 when the respective wheels 3 are assumed as references for the corresponding wheel speeds ωw1 to ωw4. The calculation is based on the wheel speeds ωw1 to ωw4, the yaw rate y, the previous estimated vehicle body speed Vn-1, and the tread values of the respective wheels 3. Moreover, the error correction unit 130 determines, in a reference wheel selection unit 132, which of the center-of-gravity vehicle body speeds VG1 to VG4 is selected and output. In the present embodiment, the error correction unit 130 sets the third highest value among the center-of-gravity vehicle body speeds VG1 to VG4 as a CAN vehicle body speed Vs based on the wheel speed ωw acquired through CAN communication, and outputs the set value. That is, the CAN vehicle body speed Vs is a speed based on the measured value of the wheel speed ωw earlier by the delay time Δt1 of CAN communication.

When the CAN vehicle body speed Vs based on the measured value earlier by the delay time Δt1 is calculated as described above, the error correction unit 130 corrects the past estimated vehicle body speed Vp, calculated earlier by the delay time Δt1, using the can vehicle body speed Vs. Specifically, the error correction unit 130 calculates, in an error calculation block 133, an error ΔV with respect to the past estimated vehicle body speed Vp calculated earlier by the delay time Δt1. In addition, the error correction unit 130 calculates, in a filter block 134, a filtered CAN vehicle body speed Vsf obtained by multiplying the CAN vehicle body speed Vs by a filter coefficient k, as shown in Equation (1). The filter coefficient k is the function of the CAN vehicle body speed Vs. The filter coefficient k is set to a value of 0.5, for example, when the absolute value of the CAN vehicle body speed Vs is greater than or equal to a second predetermined speed, and is set to a value of 0, for example, when the absolute value of the CAN vehicle body speed Vs is less than the second predetermined speed. The second predetermined speed is a speed to the extent that the wheel speeds ωw1 to ωw4 can be detected by the acceleration sensor 15, for example, 1 m/s. As thus described, when the wheel speeds ωw1 to ωw4, which are measured values, cannot be detected, the filter coefficient k is set to the value 0, whereby it is possible not to consider the error between the past estimated vehicle body speed Vp and the CAN vehicle body speed Vs based on the actual measurements.

$$Vsf = k \cdot Vs \qquad ( 1 )$$

Moreover, as shown in Equation (2), the error correction unit 130 calculates, in a multiplication block 135, an error correction value ΔVα that is the multiplication value between the calculated error ΔV and the filtered CAN vehicle body speed Vsf. Therefore, the error correction value ΔVα becomes larger when the error ΔV is larger, and becomes smaller when the error ΔV is smaller. As described above, when the absolute value of the CAN vehicle body speed Vs is less than the second predetermined speed, and the wheel speeds ωw1 to ωw4, which are the measured values, cannot be detected, the filter coefficient k in Equation (1) is the value 0, and hence the filtered CAN vehicle body speed Vsf is also the value 0.

Therefore, the error correction value ΔVα is also calculated as the value 0.

$$Δ V α = Vsf \cdot Δ V \qquad ( 2 )$$

Then, as shown in Equation (3), the error correction unit 130 adds the past estimated vehicle body speed Vp and the error correction value ΔVα in an addition block 136 to calculate and output a corrected past estimated vehicle body speed Vp′ obtained by correcting the past estimated vehicle body speed Vp. This enables the past estimated vehicle body speed Vp to be corrected on the basis of the error ΔV with respect to the CAN vehicle body speed Vs based on the measured value. When the error ΔV between the CAN vehicle body speed Vs and the past estimated vehicle body speed Vp is larger, the corrected past estimated vehicle body speed Vp′ becomes a value that is obtained by correcting the past estimated vehicle body speed Vp more significantly so as to approach the CAN vehicle body speed Vs.

$${Vp}^{′} = Vp + Δ V α \qquad ( 3 )$$

### (Estimated Vehicle Body Speed Calculation Unit)

The vehicle body speed calculation unit 140 calculates the current estimated vehicle body speed V by adding the delay correction amount α (one of the first delay correction amount α1 or the second delay correction amount α2), calculated by the delay correction amount calculation unit 120, to the corrected past estimated vehicle body speed Vp′ calculated by the error correction unit 130. That is, the current estimated vehicle body speed V can be obtained by adding the delay correction amount α, which is an estimated increase or decrease in vehicle body speed during the delay time Δt1, to the corrected past estimated vehicle body speed Vp′ earlier by the delay time Δt1.

### (Estimated Vehicle Body Speed Calculation Process)

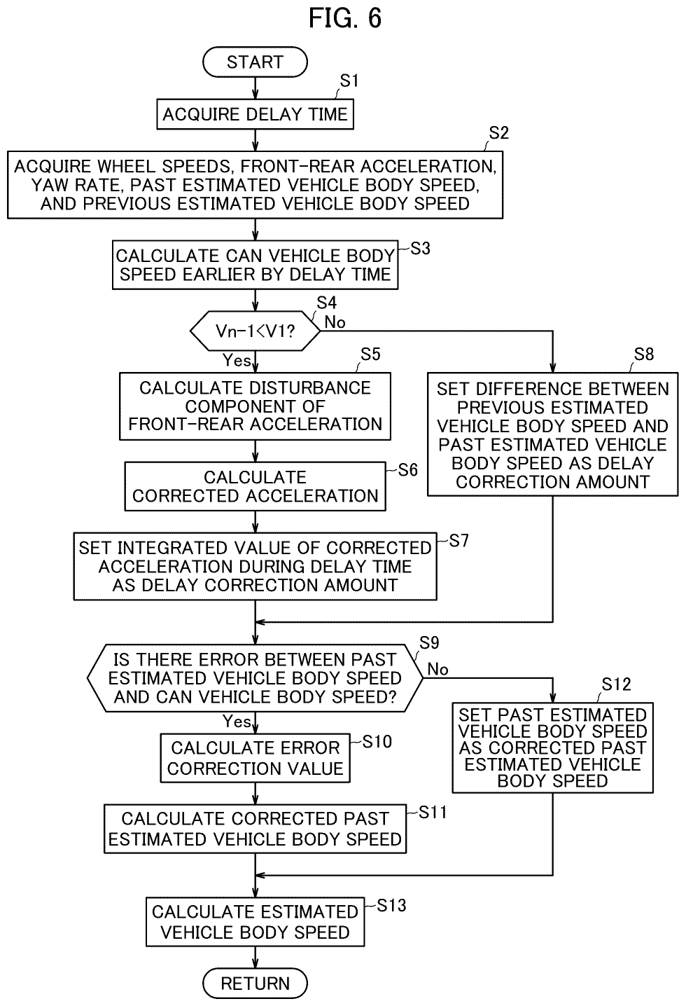

FIG. 6 is a flowchart illustrating an example of the estimated vehicle body speed calculation process. The process illustrated in FIG. 6 is repeatedly executed in a predetermined cycle by the estimated vehicle body speed calculation unit 100. The estimated vehicle body speed calculation unit 100 acquires the delay time Δt1 from a map predetermined according to the vehicle conditions (step S1). The estimated vehicle body speed calculation unit 100 acquires the wheel speeds βw1 to ωw4, the front-rear acceleration X, and the yaw rate y through CAN communication, and also acquires the previous estimated vehicle body speed Vn-1 calculated in the previous process and the past estimated vehicle body speed Vp calculated earlier by the delay time Δt1 (step S2). Next, the estimated vehicle body speed calculation unit 100 sets the acquired wheel speeds ωw1 to ωw4 as the wheel speeds earlier by the delay time Δt1 and calculates, in the error correction unit 130, the CAN vehicle body speed Vs earlier by the delay time Δt1, based on the wheel speeds ωw1 to ωw4, the yaw rate y, and the previous estimated vehicle body speed Vn-1 (step S3).

Next, the estimated vehicle body speed calculation unit 100 determines whether the previous estimated vehicle body speed Vn-1 is less than the first predetermined speed V1 (step S4). When the estimated vehicle body speed calculation unit 100 determines that the previous estimated vehicle body speed Vn-1 is less than the first predetermined speed V1 (Yes in step S4), first, in the disturbance correction unit 110, the estimated vehicle body speed calculation unit 100 calculates the disturbance component XU of the front-rear acceleration X based on the front-rear acceleration X and the derivative value dV/dt between the delay time Δt1 of the estimated vehicle body speed V (step S5). Moreover, in the disturbance correction unit 110, the estimated vehicle body speed calculation unit 100 calculates the corrected acceleration X′ obtained by subtracting the disturbance component Xα from the front-rear acceleration X (step S6). Next, the estimated vehicle body speed calculation unit 100 calculates the integrated value σX′ obtained by integrating the corrected acceleration X′ during the delay time Δt1, sets the integrated value σX′ as the delay correction amount α (first delay correction amount α1) (step S7), and proceeds to the process of step S9. On the other hand, when determining that the current vehicle body speed is equal to or greater than the first predetermined speed V1 (No in step S4), the estimated vehicle body speed calculation unit 100 sets the difference between the previous estimated vehicle body speed Vn-1 and the past estimated vehicle body speed Vp as the delay correction amount α (second delay correction amount α2) (step S8), omits the processes of steps S5 to S7, and proceeds to the process of step S9.

Next, the estimated vehicle body speed calculation unit 100 compares the past estimated vehicle body speed Vp earlier by the delay time Δt1 with the CAN vehicle body speed Vs earlier by the delay time Δt1 calculated in step S3, and determines whether there is an error ΔV (step S9). When determining that there is an error ΔV between the past estimated vehicle body speed Vp and the CAN vehicle body speed Vs earlier by the delay time Δt1 (Yes in step S9), the estimated vehicle body speed calculation unit 100 calculates, in the error correction unit 130, an error correction value ΔVα based on the error ΔV according to the above Equations (1) and (2) (step S10). Then, the estimated vehicle body speed calculation unit 100 calculates the corrected past estimated vehicle body speed Vp′ by adding the error correction value ΔVα to the past estimated vehicle body speed Vp according to the above Equation (3) (step S11), and proceeds to the process of step S13.

On the other hand, when determining that there is no error ΔV between the past estimated vehicle body speed Vp and the CAN vehicle body speed Vs earlier by the delay time Δt1 (No in step S9), the estimated vehicle body speed calculation unit 100 sets the past estimated vehicle body speed Vp as the corrected past estimated vehicle body speed Vp′ (step S12) and proceeds to the process of step S13. That is, since the error ΔV is the value 0, the error correction value ΔVα calculated by the above Equations (1) and (2) is also the value 0, and in the above Equation (3), the value of the past estimated vehicle body speed Vp is output as it is as the corrected past estimated vehicle body speed Vp′.

Next, the estimated vehicle body speed calculation unit 100 calculates the current estimated vehicle body speed V by adding the delay correction amount α (one of the first delay correction amount α1 or the second delay correction amount α2) to the calculated corrected past estimated vehicle body speed Vp′ (step S13), and executes this routine again from step S1.

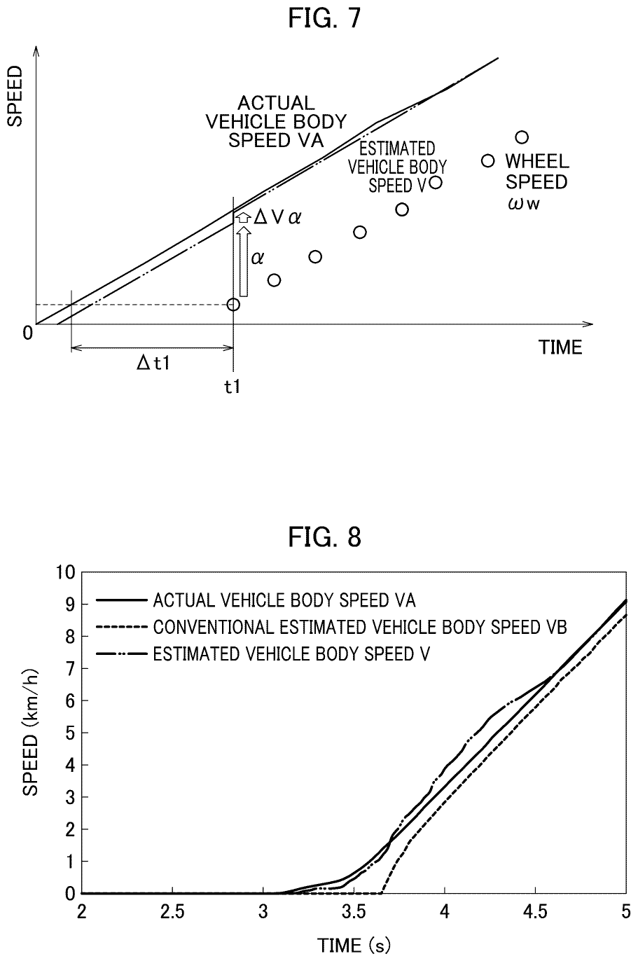

The behavior of the estimated vehicle body speed V calculated by the estimated vehicle body speed calculation process as above will be described in detail with reference to FIG. 7. FIG. 7 is an explanatory diagram schematically illustrating the behavior of the estimated vehicle body speed V by the estimated vehicle body speed calculation process according to the embodiment. FIG. 7 illustrates the time variations of the estimated vehicle body speed V calculated in the estimated vehicle body speed calculation process (cf. dash-double-dots line), the wheel speed ωw acquired by the ECU 10 through CAN communication (cf. white circle), and the actual vehicle body speed VA (cf. solid line).

First, immediately after the start of the electric vehicle 1 and until time t1 at which the wheel speed ωw is detected, the filter coefficient k in Equation (1) is set to the value 0 in the error correction unit 130, so that the error correction value ΔVα in Equation (2) is the value 0, and the past estimated vehicle body speed Vp is set as the corrected past estimated vehicle body speed Vp′. Then, as illustrated by the solid white arrow in the figure, the estimated vehicle body speed V obtained by adding the delay correction amount α to the past estimated vehicle body speed Vp is calculated until time t1. In other words, according to the configuration of the present embodiment, the estimated vehicle body speed V can be calculated even until time t1 at which the wheel speed ωw is detected. In the initial stage of the estimated vehicle body speed calculation process, when the past estimated vehicle body speed Vp itself does not exist yet, both terms on the right side of the above Equation (3) are the value 0. Therefore, the corrected past estimated vehicle body speed Vp′ is the value 0, and hence the value of the delay correction amount α becomes the estimated vehicle body speed V as it is.

When the wheel speed ωw starts to be detected at time t1, in the error correction unit 130, the error correction value ΔVα is calculated according to the above Equations (1) and (2), and the corrected past estimated vehicle body speed Vp′ is calculated by correcting the past estimated vehicle body speed Vp according to Equation (3). Then, the estimated vehicle body speed V, obtained by adding the delay correction amount α to the corrected past estimated vehicle body speed Vp′, is calculated.

That is, as illustrated by the white arrow in the figure, after time t1, the error correction value ΔVα is added to the past estimated vehicle body speed Vp in addition to the delay correction amount α. In other words, the corrected past estimated vehicle body speed Vp′ corrected based on the measured value of the wheel speed ωw becomes the reference value used in calculating the estimated vehicle body speed V, and the delay correction amount α is added to this reference value. This leads to an improvement in the calculation accuracy of the estimated vehicle body speed V, bringing the estimated vehicle body speed V closer to the actual vehicle body speed VA.

FIG. 8 is an explanatory diagram illustrating an example of experimental results in which the estimated vehicle body speed was calculated using the estimated vehicle body speed calculation process according to the embodiment. FIG. 8 illustrates the time variation behavior of the actual vehicle body speed VA, the conventional estimated vehicle body speed VB calculated using the conventional method, and the estimated vehicle body speed V calculated using the estimated vehicle body speed calculation process according to the embodiment while the electric vehicle 1 is traveling. The actual vehicle body speed VA here is a value detected by a global positioning system (GPS) device installed in the electric vehicle 1. As illustrated in the figure, it can be seen that the estimated vehicle body speed V calculated using the estimated vehicle body speed calculation process according to the embodiment follows the actual vehicle body speed VA more closely than the conventional estimated vehicle body speed VB, especially in the extremely low-speed region immediately after the start of the electric vehicle 1 (the region where the actual vehicle body speed VA is about 2 km/h). It can also be seen that the estimated vehicle body speed V follows the actual vehicle body speed VA more closely than the conventional estimated vehicle body speed VB even in the region where the actual vehicle body speed VA is about 7 km/h or more.

### (Traction Control Unit)

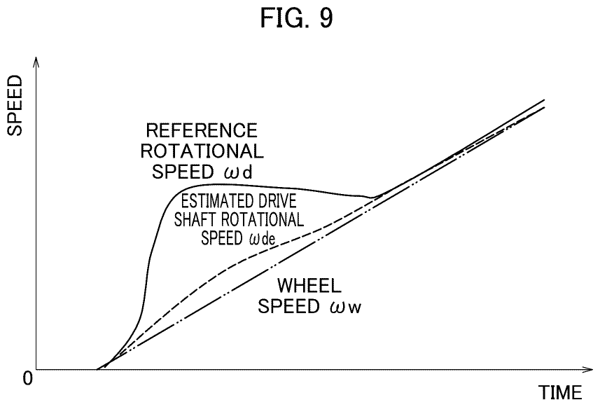

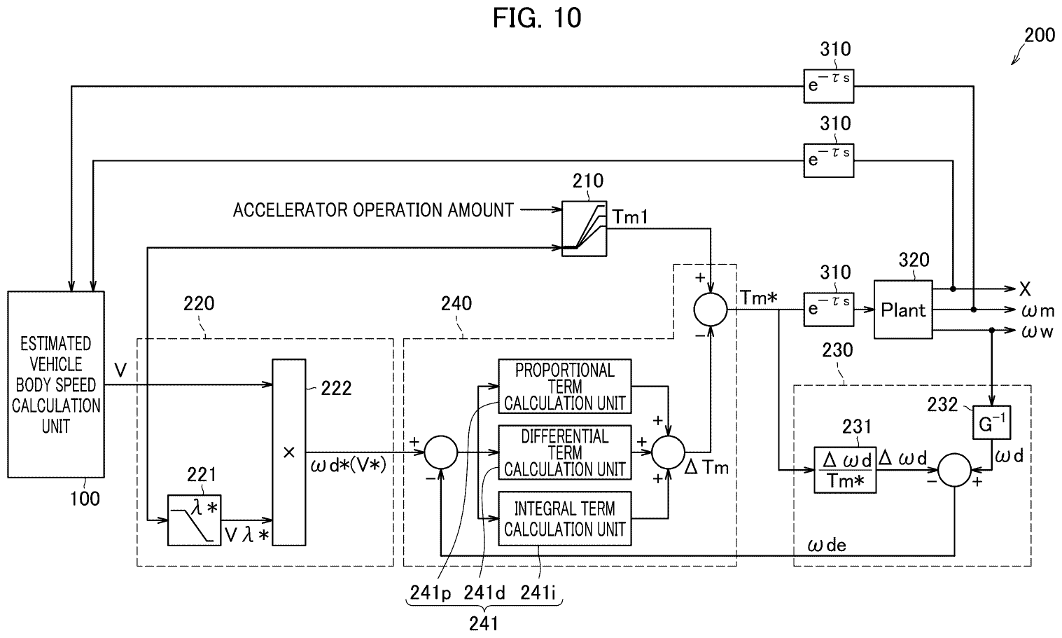

Next, the traction control unit 200 will be described. Here, FIG. 9 is an explanatory diagram schematically illustrating the time variations of a reference rotational speed ωd of the drive shaft 5 and the wheel speed ωw. Note that FIG. 9 also illustrates the value of an estimated drive shaft rotational speed ωde, which will be described later. The reference rotational speed ωd is a value calculated by dividing the motor rotational speed ωm by the reduction ratio of the reduction mechanism 4. As illustrated in the figure, the occurrence of the torsion of the drive shaft 5 causes a deviation between the reference rotational speed ωd and the wheel speed ωw. Thus, using the reference rotational speed ωd of the drive shaft 5 as it is for traction control can lead to a deterioration in control accuracy. Therefore, in the ECU 10 of the present embodiment, the traction control unit 200 more appropriately calculates the rotational speed of the drive shaft 5 and executes traction control.

FIG. 10 is a control block diagram illustrating an example of the configuration of the traction control unit 200. As illustrated in FIGS. 2 and 10, the traction control unit 200 includes a required torque setting unit 210, a target drive shaft rotational speed calculation unit 220, an estimated drive shaft rotational speed calculation unit 230, and a torque command value calculation unit 240. Note that a delay block 310 in the figure indicates that a control delay occurs due to a communication delay or other reasons. A plant block 320 in the figure is a control block indicating that the electric vehicle 1 is driven and controlled by a torque command value Tm* or the like, and FIG. 10 illustrates an example of outputting the values of the motor rotational speed ωm, the wheel speed ωw, and the front-rear acceleration X.

### (Required Torque Setting Unit)

The required torque setting unit 210 acquires the accelerator operation amount from the accelerator sensor 13 and acquires the current estimated vehicle body speed V from the estimated vehicle body speed calculation unit 100. Based on the acquired accelerator operation amount and the current estimated vehicle body speed V, the required torque setting unit 210 sets and outputs a required torque Tm1 to the motor 2 from a predetermined map.

### (Target Drive Shaft Rotational Speed Calculation Unit)

The target drive shaft rotational speed calculation unit 220 acquires the current estimated vehicle body speed V calculated by the estimated vehicle body speed calculation unit 100. The target drive shaft rotational speed calculation unit 220 calculates, in a target slip ratio multiplication block 221, a value Vλ* obtained by multiplying the estimated vehicle body speed V by a target slip ratio λ*. Further, the target drive shaft rotational speed calculation unit 220 calculates a target slip speed V* by multiplying the estimated vehicle body speed V by the value Vλ* in a target slip ratio calculation block 222, and outputs the calculated target slip speed V* as a target drive shaft rotational speed ωd*. Note that the target slip ratio λ* is the target value of the slip ratio of the front wheel 3a when the wheel 3 to be controlled is the front wheel 3a, and is defined by a map with its value predetermined according to the estimated vehicle body speed V, for example.

### (Drive Shaft Rotational Speed Calculation Unit)

The estimated drive shaft rotational speed calculation unit 230 acquires the torque command value Tm* set by the torque command value calculation unit 240, which will be described later. The estimated drive shaft rotational speed calculation unit 230 acquires the motor rotational speed om driven and controlled by the torque command value Tm*. Then, the estimated drive shaft rotational speed calculation unit 230 estimates, in a deviation calculation unit 231, a deviation Δωd between the reference rotational speed ωd and the wheel speed ωw of the front wheel 3a based on the acquired torque command value Tm* and vehicle specifications according to a transfer function G(s) defined by the following Equation (4). The deviation Δωd is the deformation speed of the drive shaft 5.

On the right side in Equation (4), “Jall” is a value obtained by converting the inertia of the entire vehicle body of the electric vehicle 1 into the inertia of the front wheel 3a (hereinafter referred to as “vehicle body-side inertia Jall”), and “Jm” is the inertia of the motor 2 (hereinafter referred to as “motor inertia Jm”). In addition, “D” is the damping coefficient of the entire drive system including all the power transmission mechanisms that transmit the output of the motor 2 to the front wheel 3a, and “K” is the spring coefficient of the entire drive system. These constants are preset values as the vehicle specifications of the electric vehicle 1. Note that Equation (4) assumes that the wheel 3 is in the state of gripping the road surface.

$$Δ ω d / {Tm}^{*} = G ( s ) = Jall \cdot s 2 / ( Jall \cdot ( Jm + D ) \cdot s 2 + ( Jm \cdot D + Jall \cdot K ) \cdot s + Jm \cdot K ) \qquad ( 4 )$$

However, the inertia “Jall” of the entire vehicle body is calculated by the following Equation (5), for example. In Equation (5), “Jw” is the inertia of the front wheel 3a, “r” is the effective radius of the front wheel 3a, “M” is the mass of the electric vehicle 1, and “λ” is the slip ratio of the front wheel 3a. The slip ratio λ is calculated based on, for example, the current estimated vehicle body speed V and the wheel speed ωw of the front wheel 3a, using the following Equation (6). As shown in Equation (5), the vehicle body-side inertia Jall becomes smaller when the slip ratio λ is larger. Note that the vehicle body-side inertia Jall is not limited to that calculated based on Equation (5), and may be corrected to become smaller when the slip ratio λ is larger, by multiplying the vehicle body-side inertia Jall, as a predetermined vehicle specification, by a correction factor predetermined according to the slip ratio λ.

$$Jall = 2 \cdot Jw + r 2 \cdot M \cdot ( 1 - λ ) \qquad ( 5 )$$

$$λ = ( V - ω w ) / V \qquad ( 6 )$$

The estimated drive shaft rotational speed calculation unit 230 then calculates the reference rotational speed ωd of the drive shaft 5 by dividing the motor rotational speed ωm by the reduction ratio G of the reduction mechanism 4 in a reference rotational speed calculation unit 232. Moreover, the estimated drive shaft rotational speed calculation unit 230 calculates the estimated drive shaft rotational speed ode by reducing the deviation Δωd from the reference rotational speed od, that is, the component of the deformation speed caused by the torsion of the drive shaft 5, according to the following Equation (7). The estimated drive shaft rotational speed calculation unit 230 outputs the calculated estimated drive shaft rotational speed ode to the torque command value calculation unit 240.

$$ω de = ω d - Δ ω d \qquad ( 7 )$$

### (Torque Command Value Calculation Unit)

The torque command value calculation unit 240 acquires the target drive shaft rotational speed ωd* and the estimated drive shaft rotational speed ode, executes feedback control based on the target drive shaft rotational speed ωd* and the estimated drive shaft rotational speed ωde, and calculates the torque command value Tm* of the motor 2. More specifically, the torque command value calculation unit 240 calculates the difference between the target drive shaft rotational speed ωd* and the estimated drive shaft rotational speed ωde, and outputs the difference to a proportional-integral-derivative (PID) control block 241. The PID control block 241 calculates a proportional term for the difference in a proportional term calculation unit 241p, calculates a differential term for the difference in a differential term calculation unit 241d, and calculates an integral term for the difference in an integral term calculation unit 241i. The torque command value calculation unit 240 calculates a feedback correction amount ΔTm by adding the proportional term, integral term, and differential term calculated by the PID control block 241. The feedback correction amount ΔTm is calculated as a correction amount for setting the torque command value Tm* of the motor 2 by correcting the required torque Tm1 so that the reference rotational speed ωd of the drive shaft 5 as the output value approaches the target drive shaft rotational speed ωd*. In a difference block 242, the torque command value calculation unit 240 acquires the required torque Tm1 from the required torque setting unit 210 and calculates the torque command value Tm* for the motor 2 by subtracting the feedback correction amount ΔTm from the required torque Tm1. This drives the motor 2 at the torque command value Tm*.

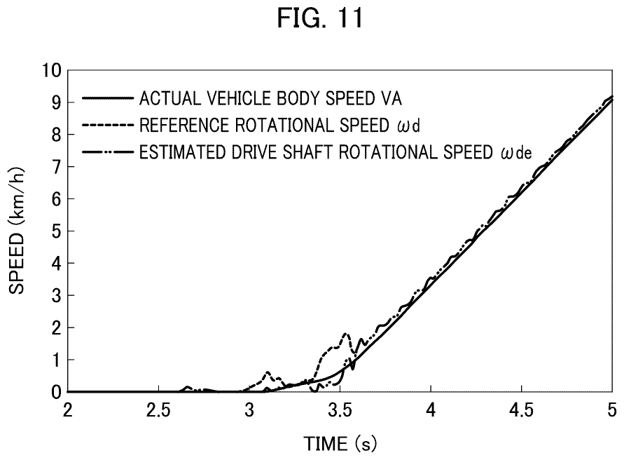

As described above, the deviation Δωd, that is, the component of the deformation speed due to the torsion of the drive shaft 5, is subtracted from the reference rotational speed ωd, whereby the estimated drive shaft rotational speed ωde can be calculated accurately by following the wheel speed ωw, as illustrated in FIG. 9. FIG. 11 is an explanatory diagram illustrating an example of experimental results in which the estimated drive shaft rotational speed was calculated by the ECU 10 according to the embodiment. FIG. 11 illustrates the time variations of the reference rotational speed ωd of the drive shaft 5, the estimated drive shaft rotational speed ωde, and the actual vehicle body speed VA. Note that the actual vehicle body speed VA is the vehicle body speed acquired by GPS, as described above. As illustrated in the figure, the estimated drive shaft rotational speed ωde follows the actual vehicle body speed VA more closely than the reference rotational speed ωd in the low-speed region.

### Effects of Embodiment

As described above, the ECU 10 (control device) of the electric vehicle 1 according to the embodiment is a control device for calculating the estimated vehicle body speed V of the electric vehicle 1 equipped with the motor 2 (motor for travel). The ECU 10 includes: the delay correction amount calculation unit 120 that calculates, as a delay correction amount α, an estimated increase or decrease in vehicle body speed during a delay time occurring when the wheel speed ωw is acquired through the wheel speed sensor 12 and CAN communication, the calculation being based on one of the front-rear acceleration X of the electric vehicle 1 and the estimated vehicle body speed V; the error correction unit 130 that calculates the corrected past estimated vehicle body speed Vp′, obtained by correcting the past estimated vehicle body speed Vp, based on an error ΔV between the past estimated vehicle body speed Vp and the CAN vehicle body speed Vs, the past estimated vehicle body speed being the estimated vehicle body speed V calculated earlier by the delay time Δt1, the CAN vehicle body speed being based on the wheel speed ωw acquired through CAN communication; and the vehicle body speed calculation unit 140 that calculates the current estimated vehicle body speed V by adding the delay correction amount α and the corrected past estimated vehicle body speed Vp′.

With this configuration, the past estimated vehicle body speed Vp, calculated earlier by the delay time Δt1 of the CAN communication delay and the wheel speed sensor 12 detection delay, can be corrected based on the wheel speed ωw acquired through CAN communication to accurately calculate the corrected past estimated vehicle body speed Vp′ that serves as a base. The current estimated vehicle body speed V is calculated by adding the delay correction amount α, which is the estimated increase or decrease in vehicle body speed during the delay time Δt1, to the corrected past estimated vehicle body speed Vp′, thus enabling the compensation of the vehicle body speed for the delay time Δt1. Therefore, according to the ECU 10 of the embodiment, it is possible to estimate the vehicle body speed more appropriately by considering the delay time Δt1 until the wheel speed ωw is detected by the wheel speed sensor 12 and acquired through CAN communication.

The delay correction amount calculation unit 120 calculates the integrated value σX′ of the front-rear acceleration X (in the embodiment, the corrected acceleration X′) of the electric vehicle 1 during the delay time Δt1 as the delay correction amount α (first delay correction amount (α1). With this configuration, the delay correction amount calculation unit 120 can appropriately calculate the delay correction amount α based on the front-rear acceleration X.

The front-rear acceleration X is a value detected by the acceleration sensor 15 installed in the electric vehicle. With this configuration, the front-rear acceleration X can be easily acquired. When the front-rear acceleration X detected by the acceleration sensor 15 is used for this control, a communication delay may occur when the ECU 10 acquires the front-rear acceleration X through CAN communication. It is thus preferable for the ECU 10 to use the front-rear acceleration X detected by the acceleration sensor 15 when the fluctuation amount of the front-rear acceleration X within a predetermined time is within a predetermined range. When the fluctuation amount of the front-rear acceleration X within the predetermined time is greater than the predetermined range, the ECU 10 may acquire the front-rear acceleration X by other methods as described below.

The integrated value σX′ is an integrated value of the corrected acceleration X′ obtained by correcting a disturbance component including a road surface gradient. With this configuration, the integrated value σX′ can be calculated more accurately.

When the previous estimated vehicle body speed Vn-1 calculated in the previous process is equal to or greater than the first predetermined speed V1 (predetermined speed), the delay correction amount calculation unit 120 sets the difference between the previous estimated vehicle body speed Vn-1 and the past estimated vehicle body speed Vp as the delay correction amount α (second delay correction amount α2). When the previous estimated vehicle body speed Vn-1 is less than the first predetermined speed V1, the delay correction amount calculation unit 120 sets the integrated value σX′ of the front-rear acceleration X of the electric vehicle 1 during the delay time Δt1 as the delay correction amount α (first delay correction amount α1).

With this configuration, the delay correction amount calculation unit 120 can accurately calculate the delay correction amount α by simple calculation without using the front-rear acceleration X in a speed region equal to or greater than the first predetermined speed V1. In addition, the delay correction amount calculation unit 120 can appropriately calculate the delay correction amount α based on the front-rear acceleration X in a speed region below the first predetermined speed V1. Note that the corrected past estimated vehicle body speed Vp′ may be used instead of the past estimated vehicle body speed Vp.

### Modifications

This concludes the description of the embodiment, but the mode of the present invention is not limited to the present embodiment. For example, in the present embodiment, the ECU 10 as the control device of the embodiment has been applied to the electric vehicle 1 as the battery electric vehicle (BEV), but the ECU 10 is not limited to applications in battery electric vehicles (BEVs) as long as a motor for travel is provided. The ECU 10 may also be applied to vehicles such as plug-in hybrid electric vehicles (PHEVs) or hybrid electric vehicles (HEVs) that can be externally recharged or externally powered, as long as a motor for travel is provided.

In the present embodiment, the front-rear acceleration X has been a value detected by the acceleration sensor 15, but the front-rear acceleration X may be a value calculated based on the wheel speed ωw. That is, for the CAN vehicle body speed Vs calculated based on the wheel speed ωw, a derivative value during the delay time Δt1 may be calculated and the calculated derivative value may be used as the front-rear acceleration X. With this configuration, the front-rear acceleration X can be acquired only by the wheel speed sensor 12 for detecting the wheel speed ωw. When the ECU 10 acquires the wheel speed ωw, detected by the wheel speed sensor 12, through CAN communication, the delay time Δt1 occurs. Therefore, the ECU 10 may acquire the front-rear acceleration X based on the wheel speed ωw in a situation where the delay time Δt1 is small, that is, in a region where the vehicle body speed is greater than a predetermined value.

The front-rear acceleration X may be a value calculated based on the estimated vehicle body speed V. That is, the derivative value dV/dt during the delay time Δt1 may be calculated for the finally calculated estimated vehicle body speed V, and the calculated derivative value dV/dt may be used as the front-rear acceleration X. With this configuration, the front-rear acceleration X can be acquired without using the acceleration sensor 15 or the wheel speed sensor 12.

The front-rear acceleration X may be a value calculated based on the driving force and braking force of the electric vehicle 1. That is, the driving force can be calculated based on the torque command value of the motor 2. The braking force can be calculated based on the brake operation amount and brake fluid pressure detected by the brake sensor 14. The front-rear acceleration X may be calculated based on the difference between the driving force and braking force, for example, using a value obtained by dividing the vehicle weight by the difference between the above driving force and braking force. With this configuration, the front-rear acceleration X can be acquired without using the acceleration sensor 15 or the wheel speed sensor 12.

For the front-rear acceleration X, depending on the vehicle conditions, the value that can be calculated most accurately may be separated and used among the value detected by the acceleration sensor 15, the value calculated based on the wheel speed ωw, the value calculated based on the estimated vehicle body speed V, and the value calculated based on the driving force and braking force of the electric vehicle 1.

The derivative value dV/dt of the estimated vehicle body speed V used in the disturbance correction unit 110 may be calculated using one of the value calculated based on the wheel speed ωw or the value calculated based on the driving force and braking force of the electric vehicle 1 of the electric vehicle 1.

### EXPLANATION OF REFERENCE SIGNS

1 electric vehicle
2 motor
3 wheel
3a front wheel
3b rear wheel
4 reduction mechanism
drive shaft
ECU (control device)
11 motor rotational speed sensor
12 wheel speed sensor
15 acceleration sensor
100 estimated vehicle body speed calculation unit
110 disturbance correction unit
120 delay correction amount calculation unit
130 error correction unit
140 vehicle body speed calculation unit
200 traction control unit
210 required torque setting unit
220 target drive shaft rotational speed calculation unit
230 estimated drive shaft rotational speed calculation unit
231 deviation calculation unit
240 torque command value calculation unit
Jall vehicle body-side inertia
Jm motor inertia
k filter coefficient
Tm torque command value
Tm1 required torque
V estimated vehicle body speed
V1 first predetermined speed (predetermined speed)
VA actual vehicle body speed
VB conventional estimated vehicle body speed
VG1, VG2, VG3, VG4 center-of-gravity vehicle body
speed
Vn-1 previous estimated vehicle body speed
Vp past estimated vehicle body speed
Vp′ corrected past estimated vehicle body speed
Vs CAN vehicle body speed
Vsf filtered CAN vehicle body speed
X front-rear acceleration
X′ corrected acceleration
Xe estimated acceleration
Xα disturbance component
y yaw rate
α delay correction amount
α1 first delay correction amount
α2 second delay correction amount
Δt1 delay time
ΔTm feedback correction amount
ΔV error
ΔVα error correction value
Δωd deviation
λ* target slip ratio
λ slip ratio
σx integrated value
ωd reference rotational speed
ωd* target drive shaft rotational speed
ωde estimated drive shaft rotational speed
ωm motor rotational speed
ωw, ωw1, ωw2, ωw3, ωw4 wheel speed

1. A vehicle control device for calculating an estimated vehicle body speed of a vehicle equipped with an electric motor for travel, the vehicle control device comprising:
a delay correction amount calculation unit that calculates, as a delay correction amount, an estimated increase or decrease in vehicle body speed during a delay time occurring when a wheel speed is acquired through a sensor and CAN communication, the calculation being based on one of a front-rear acceleration of the vehicle and the estimated vehicle body speed;
an error correction unit that calculates a corrected past estimated vehicle body speed, obtained by correcting a past estimated vehicle body speed, based on an error between the past estimated vehicle body speed and the vehicle body speed, the past estimated vehicle body speed being the estimated vehicle body speed calculated earlier by the delay time, the vehicle body speed being based on the wheel speed acquired through CAN communication; and
a vehicle body speed calculation unit that calculates the estimated vehicle body speed at present by adding the delay correction amount and the corrected past estimated vehicle body speed.

2. The vehicle control device according to claim 1, wherein the delay correction amount calculation unit calculates an integrated value of the front-rear acceleration of the vehicle during the delay time as the delay correction amount.

3. The vehicle control device according to claim 2, wherein the front-rear acceleration is a value detected by an acceleration sensor installed in the vehicle.

4. The vehicle control device according to claim 2, wherein the front-rear acceleration is a value calculated based on the wheel speed.

5. The vehicle control device according to claim 2, wherein the front-rear acceleration is a value calculated based on the estimated vehicle body speed.

6. The vehicle control device according to claim 2, wherein the front-rear acceleration is a value calculated based on a driving force and a braking force of the vehicle.

7. The vehicle control device according to any one of claims 2 to 6, wherein the integrated value is an integrated value of a corrected acceleration obtained by correcting a disturbance component including a road surface gradient.

8. The vehicle control device according to any one of claims 2 to 6, wherein
when a previous estimated vehicle body speed that is the estimated vehicle body speed calculated in a previous process is equal to or greater than a predetermined speed, the delay correction amount calculation unit sets a difference between the previous estimated vehicle body speed and the past estimated vehicle body speed as the delay correction amount, and
when the previous estimated vehicle body speed is less than the predetermined speed, the delay correction amount calculation unit sets the integrated value of the front-rear acceleration of the vehicle during the delay time as the delay correction amount.
